(19) United States
(12) Patent Application Publication
(10) Pub. No.: US 2011/0123343 A1
(43) Pub. Date: May 26, 2011

(54) WIND TURBINE BLADE AND METHODS, APPARATUS AND MATERIALS FOR FABRICATION IN THE FIELD

(76) Inventor: David E. Ronner, Berkeley Heights, NJ (US)

(21) Appl. No.: 12/952,585

(22) Filed: Nov. 23, 2010

Related U.S. Application Data
(60) Provisional application No. 61/264,039, filed on Nov. 24, 2009.

(51) Int. Cl. B64C 27/46

(52) U.S. Cl. 416/226

(57) ABSTRACT

A wind turbine blade is provided with a core that has a plurality of sections, and a spar that has a plurality of sections and which is centrally positioned in the core. The exterior of the core is covered with a resin impregnated fabric cover that is cured. The spar and core sections of the blade may be sized to facilitate the assembly of the blade at a field construction site.

### CROSS-REFERENCE TO RELATED APPLICATIONS

The present application claims the benefit of U.S. Provisional Patent Application Ser. No. 61/264,039 filed on Nov. 24, 2009, the disclosure of which is incorporated herein by reference in its entirety.

### FIELD OF THE INVENTION

The present invention relates to the fabrication of wind turbine blades, and, more particularly, to methods, apparatus and materials for fabrication of large wind turbine blades in the field.

### BACKGROUND OF THE INVENTION

The number of installations of large wind turbines is expected to grow exponentially in the future. The length of large wind turbine blades, which now ranges from about 20 to 55 meters (65 to 180 ft), is also expected to continue to increase. The increase in the length of the blades increases the weight of the blades, which increases strength requirements for wind turbine elements such as the tower, gearbox, and hub bearings. The increase in the length of the blades also exponentially increases the cost and time associated with fully constructing the blades in a factory and then transporting them to the wind turbine construction site. Currently, wind turbine blades are constructed using framed construction and placing fiberglass infused panels into the frame structure. The assembly process is completed in a factory environment. As much as 20 percent or more of the cost of the factory fabrication of a large wind turbine blade is expended in transporting the blade from the factory to the wind turbine field installation site. This includes costs associated with securing right-of-way approvals, hiring safety and security vehicles and services, hiring drivers, employing trucks/barges/trains, and transporting the blades to the wind turbine construction site. As the size of the blade increases, the proportionate cost associated with transporting the wind turbine blade (compared to the total cost of producing the blade) also increases. What is needed is a large wind turbine blade that is able to be fully assembled in the field (e.g., at the construction site of the wind turbine) from small subcomponents that are transportable to the field via conventional shipping means (e.g., flatbed or container trailers). It is also desirable that the wind turbine blade should be lighter and therefore stronger than a similarly sized conventional wind turbine blade.

### SUMMARY OF THE INVENTION

The present invention overcomes the disadvantages and shortcomings discussed above by providing methods, apparatus and materials for the fabrication of large wind turbine blades at the wind turbine construction site. This provides significant cost and time savings over the current method of fabricating the blade in a factory and then shipping the blade to the wind turbine construction site. In addition, through the use of novel combinations of materials and construction methodologies, the overall weight of the turbine wind blade may be significantly reduced as compared to conventional wind turbine blades.

The blade has a longitudinal central support spar which supports a foam core that is covered with a tape layer of treated fabric. The spar and foam core are shipped to the field in sections, and are assembled in the field with the assistance of jigs and other apparatus. Once the spar and foam core sections are assembled into a single unit, a tape layer covering is laid up from root to tip and an outer tape covering is wound onto it from reels with the assistance of tape layup apparatus. The blade is then treated and cured with the assistance of ovens and other apparatus.

### BRIEF DESCRIPTION OF THE DRAWINGS

For a more complete understanding of the present invention, reference is made to the following detailed description of an exemplary embodiment considered in conjunction with the accompanying drawings, in which:

FIG. 1 is a perspective view of a wind turbine blade having a tape layer outer covering constructed in accordance with one embodiment of the present invention;

FIG. 2 is a plan view of the wind turbine blade shown in FIG. 1;

FIG. 3 is a cross-sectional view, taken along section line 3-3 of FIG. 2, and looking in the direction of the arrows, of the wind turbine blade shown in FIG. 2, the tape layer outer covering not being shown;

FIG. 4a is a sectional view of an offset joint shown in FIG. 3;

FIG. 4b is an exploded sectional view of foam forms shown in FIG. 3;

FIG. 5 is a sectional view of a hub end shown in FIG. 3;

FIG. 6 is a sectional view of a tip end shown in FIG. 3;

FIG. 7 is a cross-sectional view, taken along section line 7-7 of FIG. 1, and looking in the direction of the arrows, of the wind turbine blade shown in FIG. 1;

FIG. 8 is a sectional elevational view of a spar shown in FIG. 3;

FIG. 9 is a sectional view of a hub end of a spar shown in FIG. 3;

FIG. 10 is a sectional view of a flange and hub end of the spar shown in FIG. 3;

FIG. 11 is a plan view of a tape wound on a reel;

FIG. 12 is sectional view, taken along the line 12-12. and looking in the direction of the arrows, of the tape wound on the reel shown in FIG. 11;

FIG. 13 is a view of a jig with a tape winder system mounted on a winding conveyor rail;

FIG. 14 is an elevational view of the jig with the tape winder mounted on the winding conveyor rail;

FIG. 15 is a view of a tape-reel feed assembly of the tape winder;

FIG. 16 is a view of a winding track mounted in the tape winder;

FIG. 17 is a view of the tape-reel on the winding track, the tape-reel shown in phantom at various position during an application of the tape on the blade assembly;

FIG. 18 is a view of the winding conveyor, an induction furnace, and a finishing conveyor;

FIG. 19 is an enlarged view of the induction furnace shown in FIG. 18;

FIG. 20 is a view of the inductive furnace positioned in a portable shelter;

FIG. 21 is a view of the winding conveyor, the inductive furnace, and the finishing conveyor; and

FIG. 22 is a view of the blade assembly on the finishing conveyor.

### DETAILED DESCRIPTION OF THE INVENTION

The present invention provides methods and material specifications for the fabrication of light weight large windmill blades in the field. Although the methods and materials can be used in conjunction with any type of large windmill blade, it is particularly suitable for large wind turbine blades adapted for use on horizontal-axis wind turbines. Accordingly, the present invention will be described hereinafter in connection with such windmill blades. It should be understood, however, that the following description is only meant to be illustrative of the present invention and is not meant to limit the scope of the present invention, which has applicability to other types of wind turbine blades.

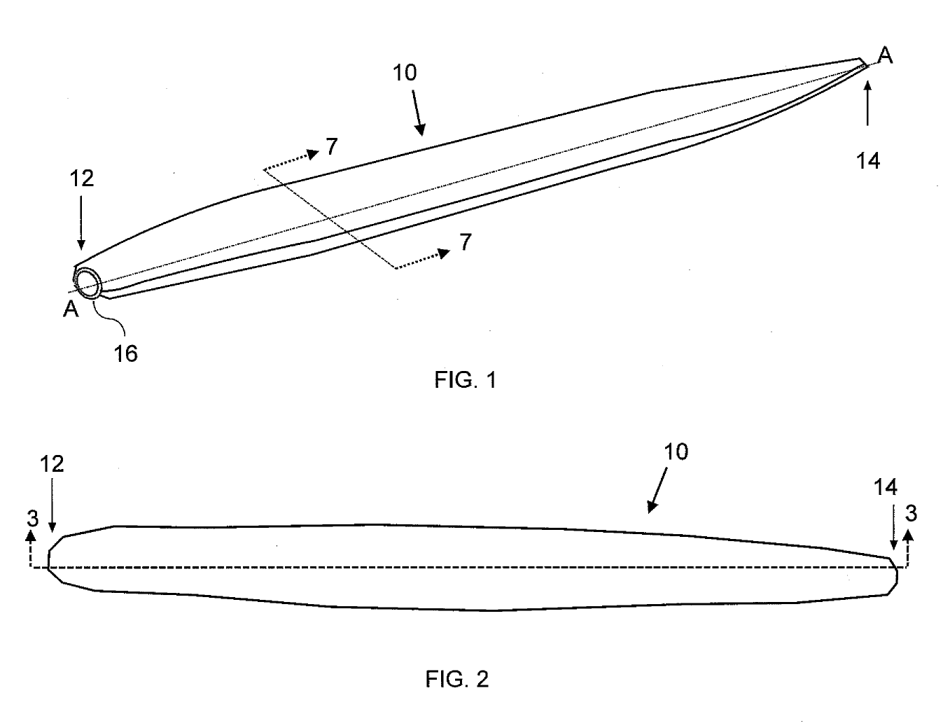

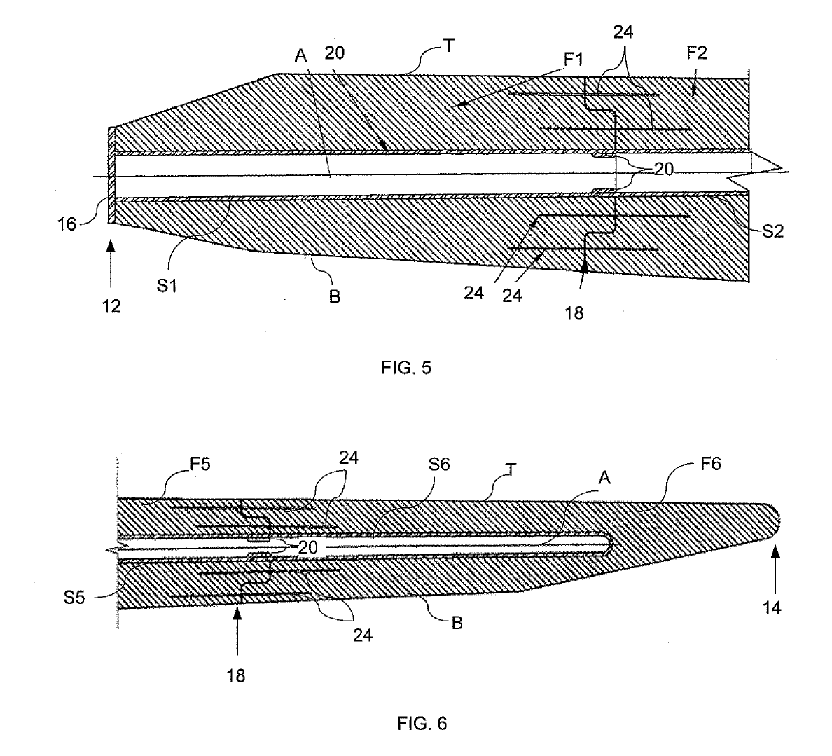

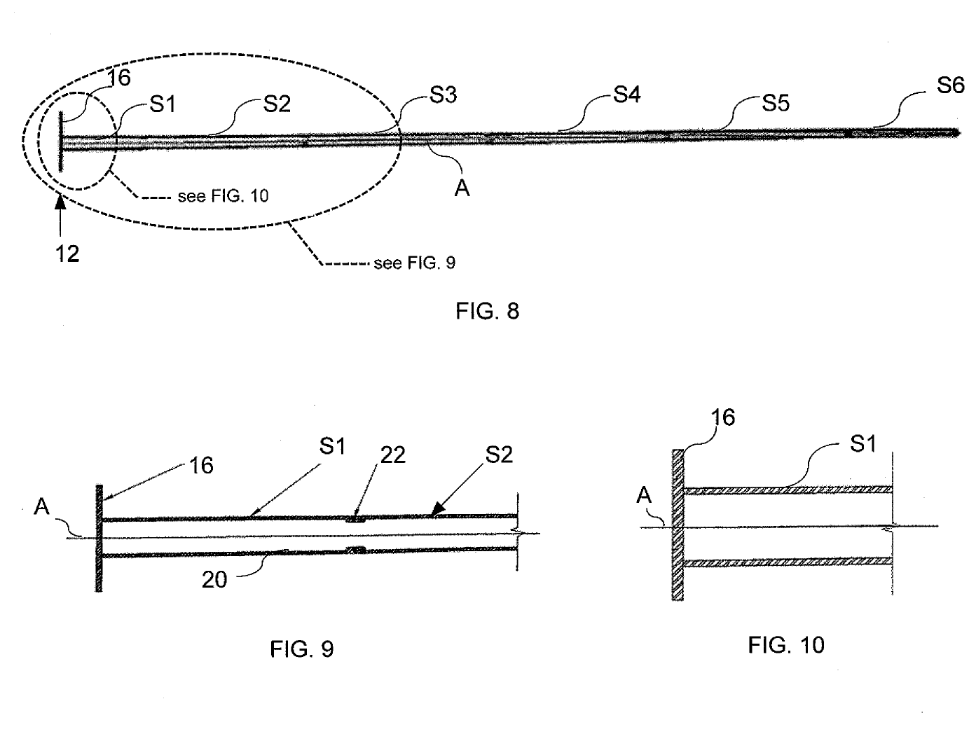

FIGS. 1-10, illustrate a wind turbine blade 10 constructed in accordance with the present invention. In general, the exterior contours and the aerodynamic characteristics of the blade 10 are equivalent to a similarly sized conventional blade; however the weight of the blade 10 is less than the weight of a similarly sized conventional blade due to the strength provided by the novel materials and composite construction disclosed here.

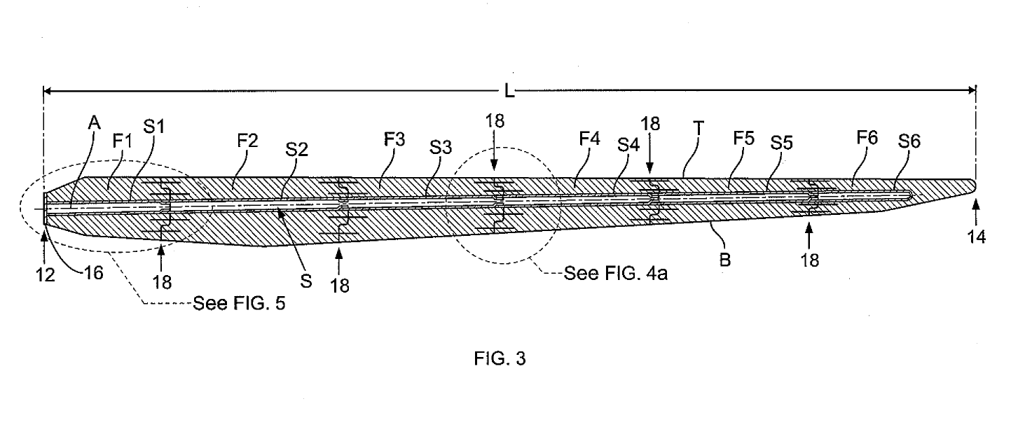

With reference to FIG. 3, the blade 10 has a top surface T and a bottom surface B, and extends a length L, from a hub end 12 to a tip end 14 along a longitudinal axis A (see also FIGS. 1 and 2). The hub end 12 has a flange 16 (see FIGS. 8-10) to facilitate the removable connection of the blade 10 to the hub of the wind turbine (not shown). A support spar S extends from the flange 16, which is positioned at the hub end 12, to approximately 90 percent of the length L of the blades 10. The support spar S supports the blade 10 and has a plurality of spar sections S1-S6 which are rigidly joined together at offset foam section joints 18 in a manner described herebelow.

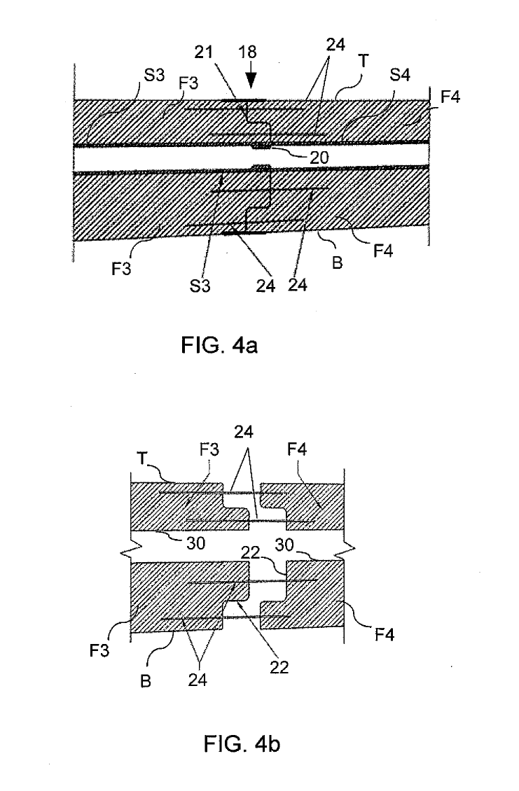

Referring to FIGS. 3-10, the support spar S is assembled in the field from spar sections S1-S6. The spar sections S1-S6 are made from lightweight, structurally strong aluminum, carbon or other suitably strong, lightweight material. Each spar section S1-S6 has an end with a keyway 20, to facilitate the interconnection of the spar sections S1-S6. More particularly, FIG. 4a illustrates the interconnected spar section S3-S4. Rivets, screws, or other suitable fasteners (not shown) are positioned proximate the keyways 20 to fixedly interconnect the spar section S3-S4.

Molded structural foam sections F1-F6 surround spar sections S1-S6, each having a length equal to the length of the corresponding spar section S1-S6 it surrounds, although the lengths may be different. The spar sections S1-S6 provide central support for the foam structure sections F1-F6 of the blade 10. The foam sections F1-F6 are precast foam form sections that are molded, heat resistant, high density, honey comb cell structures that have been prepared in sections and bought to the field construction site for field fabrication of the blade 10. The foam structures sections F1-F6 are resistant to heat and are lightweight. The heat resistance quality of the foam is necessary to resist the heat generated in a field curing process which is described hereinbelow.

The foam sections F1-F6 have end surfaces 22. A plurality of structural support pultruded wafers (not shown) are placed in the foam structure sections F1-F6 proximate the end surfaces 22, for enhancing sheering, flexural, tensile/compression strength of the joints 18. The pultruded wafers are may be fabricated with carbon composite or other suitable material. A plurality of support pins or dowels 24, which may be 6 ft. in length and 2 inches in diameter, straddle each joint 18. More particularly, the dowels 24 are inserted and glued in hollow channels (not shown) in the foam structures F1-F6. The wafers and the dowels 24 provide structural stability to the joints 18. The end surfaces 22 of the foam sections F1-F6 are coated with a glue adhesive (not shown) prior to assembling the joints 18, to strengthen the joints 18. Each of the foam sections F1-F6 has a center hole 30 that has a longitudinal axis that is coincident with the longitudinal axis A. The foam sections F1-F6 are coated with adhesives (not shown) to fixedly adhere them to the spar S.

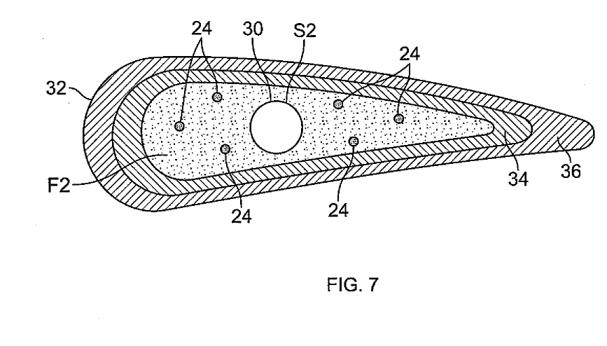

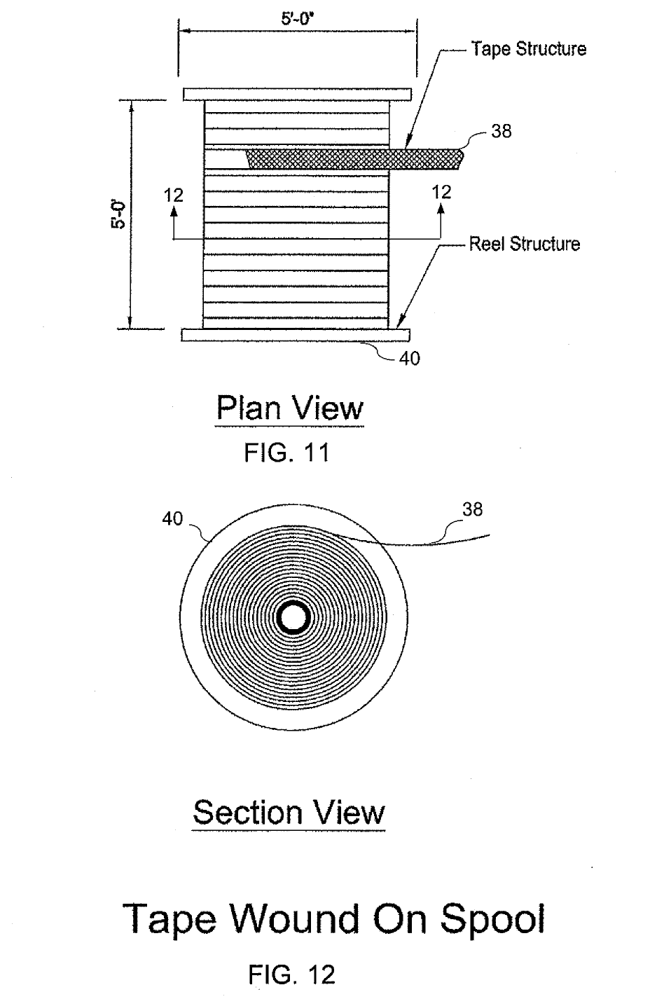

Referring now to FIGS. 7 and 11, surrounding the foam structure sections F1-F6 is an outer cover 32 (see FIG. 7). The outer cover 32 has multiple layers of fabric material which employs carbon tow constructed in a multi-axial configuration. The fabric is constructed from a carbonized tow. The fabric strength is enhanced by the carbonization process and therefore the weight of the required quantity of the fabric is reduced. The carbonized tow is stitched down in a multi-axial configuration. It is understood that various multi-axial configurations may be utilized in the construction of the cover 32.

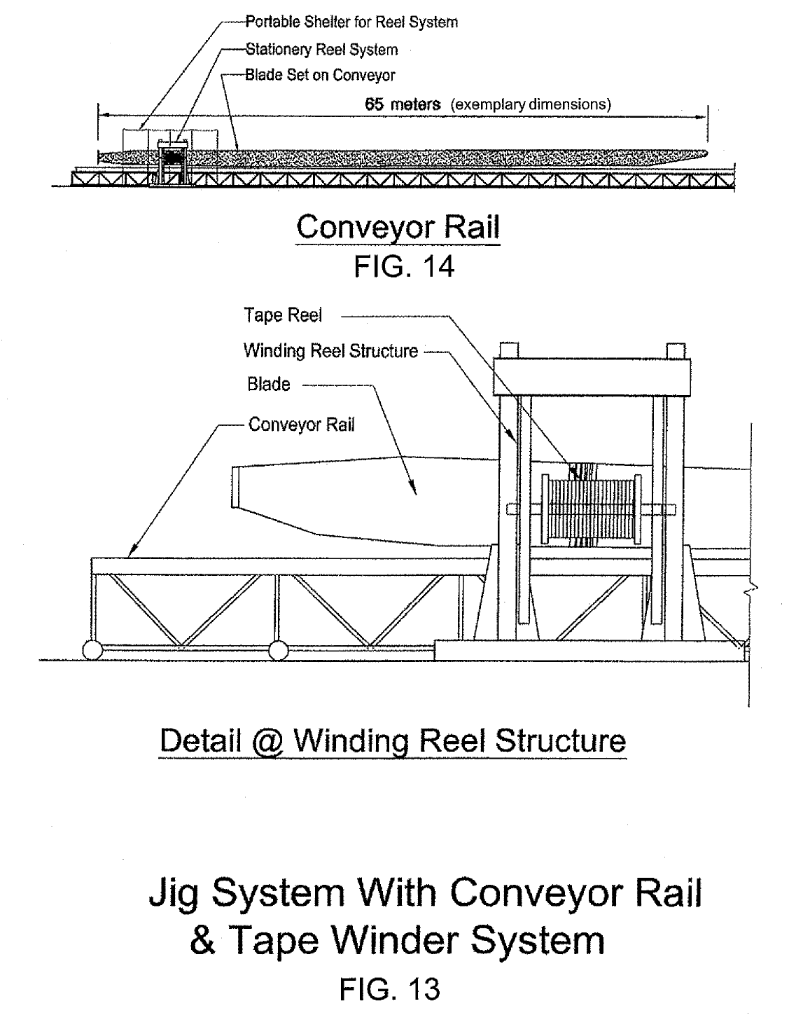

The cover 32 is constructed with an inner fabric layer 34 and an outer fabric layer 36 (see FIG. 7). More particularly, the inner fabric layer 34 is formed from sheets of fabric which are laid-up on the top surface T and bottom surface B of the blade 10, extending from the hub end 12 to the tip end 14, and extending to the perimeters of the top surface T and the bottom surface B of the blade 10. The inner fabric layer 34 is impregnated with a low-temperature thermoplastic composite resin (not shown). An outer fabric layer 36, which is made of the same multi-axial fabric as the inner layer 34 and is formed into a tape 38 (e.g., 6 inches wide), is placed on spools 40 (see FIGS. 12 and 13) prior to delivery to the field construction site. The outer fabric layer 36 is helically wound or wrapped around the inner fabric layer 34 of the cover 32. The resin is subjected to low-temperature heat causing the impregnated cover 32 to be transformed to a solid surface which enhances strain resistance to the sheer, tensile, and compression stresses (not shown) that act on the blade 10. The resin is heat activated in the field at relatively low temperatures (i.e. at temperatures that are below the melting point of the foam sections F1-F6) in order to solidify the outer cover 32 into a solid surface. More particularly, the cured resin transforms the inner and outer fabric layers 34, 36 into to a lightweight, multi-axial solid multi layer cover 32. The low-temperature resin enhances the tensile/compression and flexural strength modulus of the cover 32 which works in concert with the foam sections F1-F6, the spar sections S1-S6 to create a rigid monocoque-type blade 10 structure. The structural stability of the cover 32 is an integral part of the composite makeup of the blade 10 which contributes to the strength necessary to handle the repetitive stresses and resulting strains that are applied to the blade 10 without incurring fatigue-type failures over time. The low-temperature resin also has tack qualities that enhance the layup of the inner fabric layer 34 and the subsequent machine winding application of the outer fabric layer 36. The processes for applying the inner and outer fabric layers 34, 36 of the cover 32 on the foam structures F1-F6, and the subsequent heat curing and solidification of the inner and outer fabric layers 34, 36 are described hereinafter.

A finishing resin (not shown) is applied to the cover 32 to form the smooth skin and finish of the blade 10. The cyclo-alephatic resin is lightweight and durable. Copper ion or like material may be added to the finishing resin for enhancing the lightening strike shedding capabilities of the blade 10. The application of the cyclo-alephatic is the last step of the field fabrication process of the blade 10.

Equipment Associated with the Field Fabrication of the Blade 10

Assembly Jig

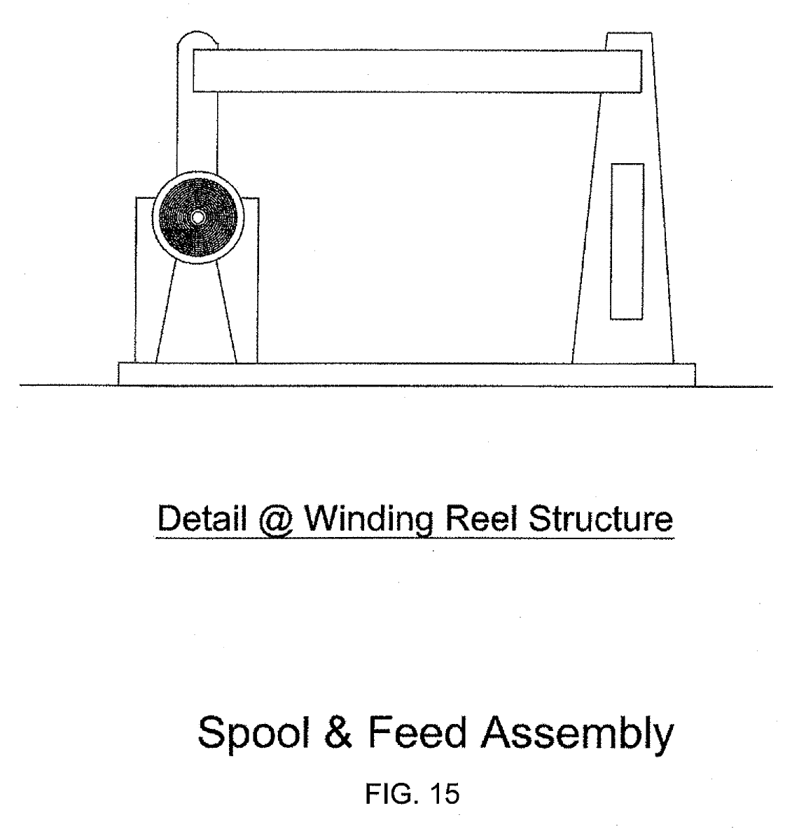

Referring to FIGS. 14 and 15, an assembly jig with a scaffold structure facilitates the field assembly of the spar S and the subsequent fitting of the foam sections F1-F6. The jig suspends each individual spar sections S1-S6 to accommodate the locking and gluing of the foam sections F1-F6. The jig has a gantry and conveyor system that allows for processing the spar section S1-S6 and the foam section F1-F6 through a process or work zone that facilitates multiple processes, which includes a tape layup, inspection and milling, heat curing, cyclo-alephatic resin application, and final inspection.

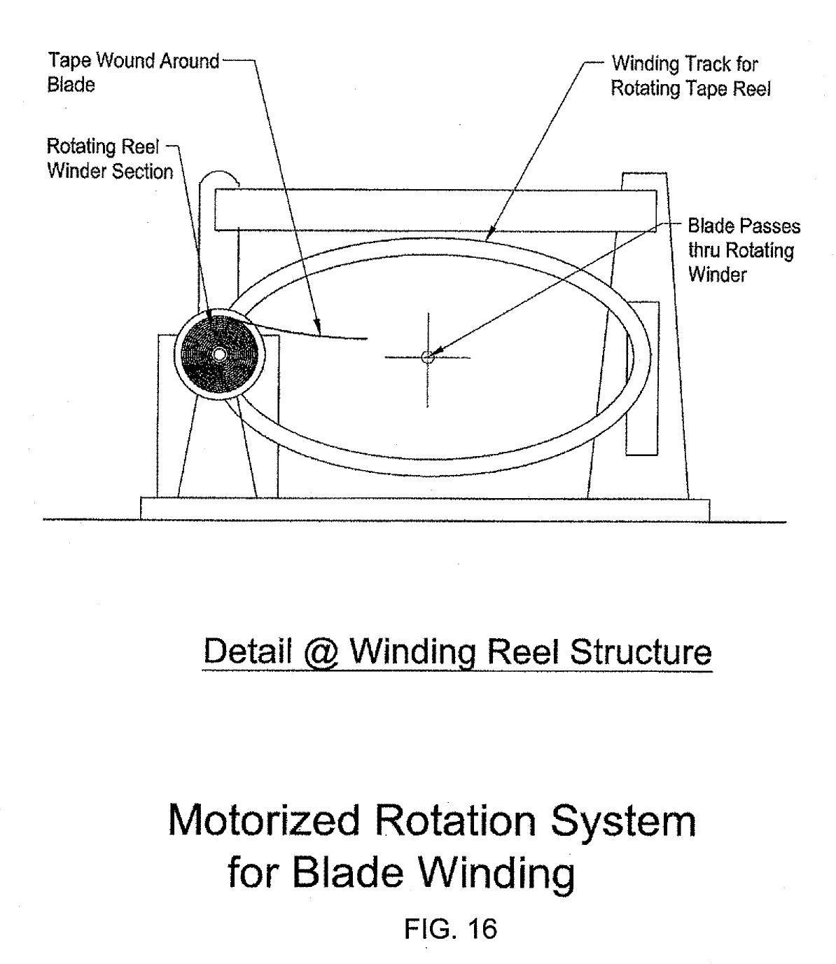

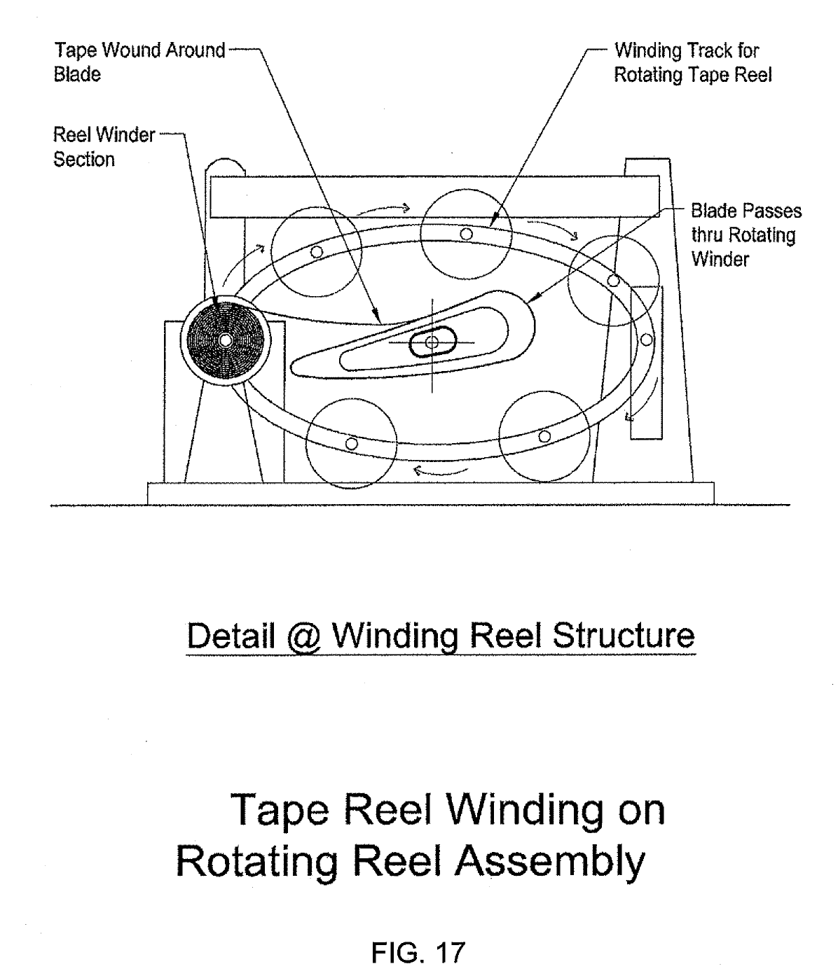

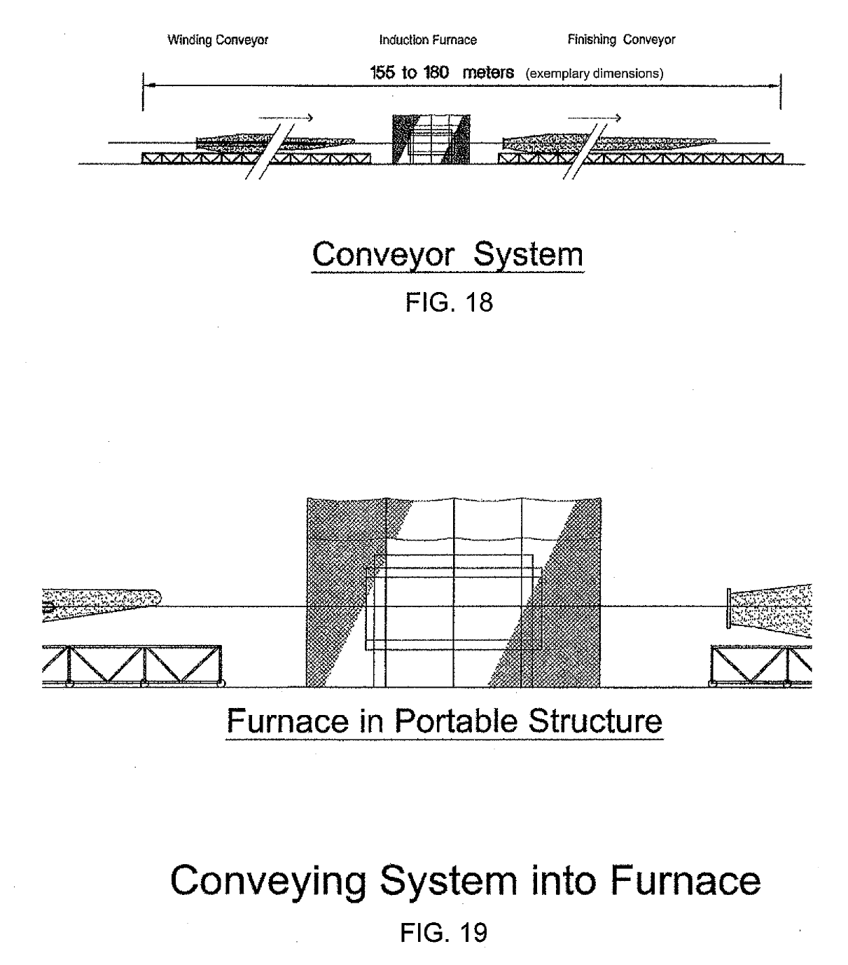

Tape Layup Equipment (See FIGS. 16-18)

Referring to FIGS. 16-18, the tape 38 that forms the outer fabric layer 36 that is prepackage on reels 40 is dispensed by tape layup equipment. The tape layup equipment is commercially available.

Inductive Furnace

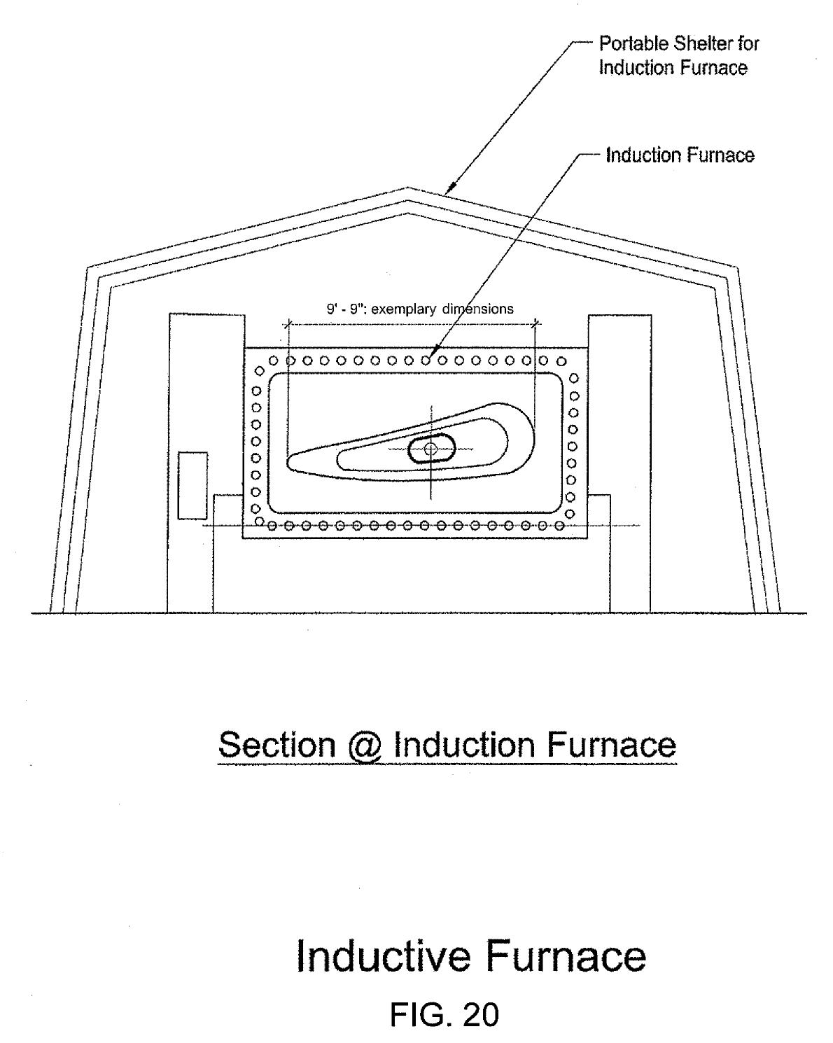

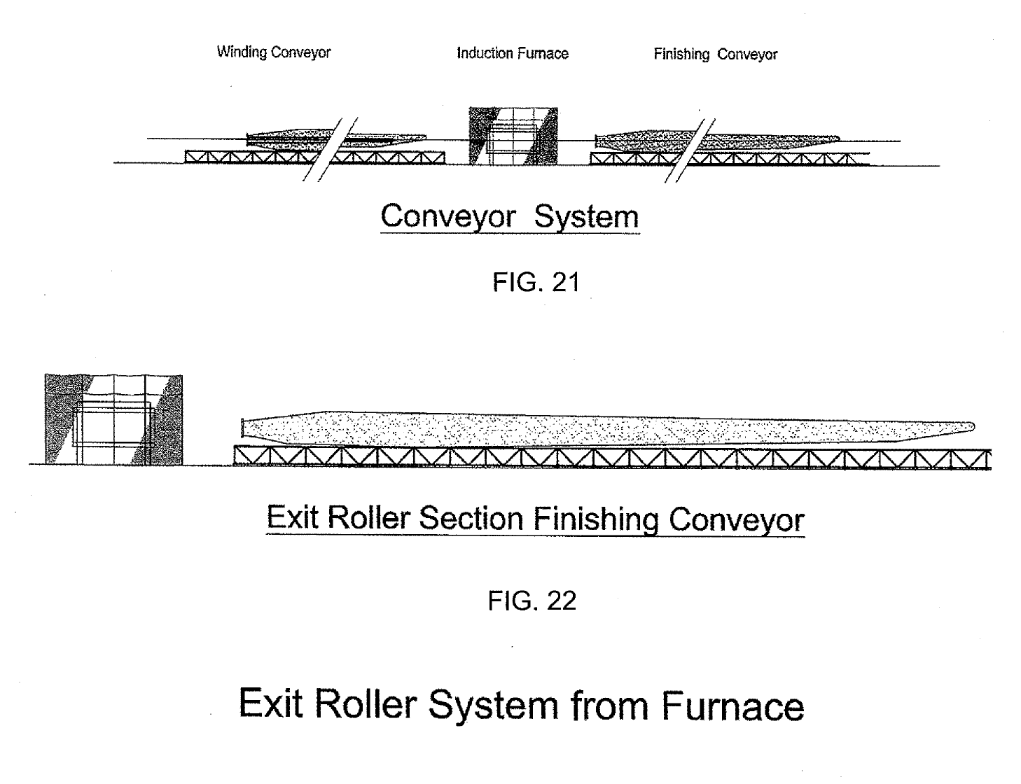

Referring to FIGS. 19-23, an inductive furnace is supported (i.e., fired) by natural gas or electricity provided in the field. The inductive furnace provides heat for the curing of the cover 32 into a solid phenolic surface covering for the blade 10. The inductive furnace equipment is commercially available.

Resin Application Station

A resin application station (not shown) includes conventional spraying equipment for applying the resin to the blade 10. This equipment is positioned in the assembly jig and is commercially available.

Processes Associated with the Field Assembly of the Blade 10

Referring to FIGS. 4a-23, all components and equipment are transported to the field construction site on standard transportation facilities such as 53 foot flatbed trailers or container trailers. The spar S is assembled prior to assembling the foam sections F1-F6. A jig structure is assembled in the field in close proximity to the location where the wind turbine will be constructed. An area of approximately 200×50 meters of level land is preferred for location of the blade 10 fabrication site. The jig assembly facilitates the assembly of the spar S. Once assembled, the spar S is suspended on the jig to facilitate fitting of the modular foam sections F1-F6. The spar S is suspended on the jig to facilitate the fitting of each of the foam sections F1-F6. The spar S is tapered. Each section of the spar section S1-S6 fits into the preceding section in a telescoping manner. The keyways 20, which have splines (not shown), facilitate interlocking the spar sections S1-S6. Predrilled holes (not shown) are provided in preceding and succeeding spar sections S1-S5. Corresponding holes (not shown) are aligned by rotating spar sections S1-S6, and rivets or screws are fitted in the holes to interlock the corresponding spar sections S1-S6 of the spar S.

The foam sections F1-F6 are pre-fabricate with geometries that define the overall outer geometry of the blade 10. The centering holes 30 facilitate positioning of the foam sections F1-F6 on the spar S. Glue is also applied to the spar S and the end surfaces 22 of the foam sections F1-F6, to facilitate interlocking the foam sections F1-F6 to each other and to the spar section S1-S6. As each foam section F1-F6 is fitted onto the spar S, and before the joints 18 are formed, the pultruded wafers and the dowels 24 are inserted into the preformed slots (not shown) and predrilled holes (not shown), respectively, of the foam sections F1-F6. The wafers and dowels 24 are glued in the foam sections F1-F6. The combination of the wafers, support dowels 24 and off-set configuration of the end surfaces 22 of the foam sections F1-F6 creates an assembly that is ready to accept the processes described below. More particularly, after the fitting of the spar sections S1-S6 to the foam sections F1-F6 is completed, the gantry on the jig traverses the blade assembly for all of the subsequent processing steps which are required to complete the wind turbine blade 10, and which are described hereinbelow

Inner Fabric Layer 34 Layup

Sheets of the fabric (i.e., as described hereinabove) used to form the multi-axial inner fabric layer 34 are shipped to the field configured in the shape and geometry of the blade 10. The inner fabric layers 34 are laid down from hub end 12 to tip end 14 on the top surface T and bottom surface B of the assembled foam sections F1-F6. The layups may be facilitated by the use of glue to hold the fabric layup in place for the subsequent tape winding methodology associated with the application of the outer fabric layer 36 of the cover 32.

Outer Fabric Layer 36 Layup

Referring to FIGS. 14-18, the tape layup equipment is moved into place. The blade assembly is processed in the work zone which is now utilized as the tape layup zone. A reel 40 of tape 38 is loaded onto the tape layup equipment. The tape layup equipment rotates around the blade assembly to wrap or wind the tape 38 onto the inner fabric layers 34. The tape layup equipment is conventional (e.g., it is used for winding airplane fuselages). The layup of the tape 38 is configured in a predetermined configuration designed to provide the greatest structural integrity for the blade 10. During the process, the layup equipment traverses the blade assembly via a rail system a rate that is consistent with a predetermined layup configuration.

The tape layup equipment preheats the tape 38 to activate the tack to assist in the layup process. A pressurized roll down device is used to compress the tape 38 on to the foam sections F1-F6. The pressure ensures adhesion and the even distribution of the tape layup. The pressure compresses each layer to insure a debulked thickness is formed. After the blade assembly exits the layup zone, the heated tape 38 is cooled with a stream of carbon dioxide gas. The cooling controls stretching and slippage, and keeps the blade assembly stable and firm. The inner fabric layer 34 and the outer fabric layer 36 of the cover 32 work in concert with each other to create a multi-axial surface that works in conjunction with the underlying assembly, creating structural integrity for the entire blade 10.

Curing the Inner and Outer Fabric Layers 34, 36 of the Cover 32

Referring to FIGS. 19-23, the layup equipment is taken out of the processing zone and replaced with an inductive furnace. The inductive furnace may, for instance, be brought to the field either as a mobile unit contained within a tractor trailer or as a unit that can be removed from a flatbed and put into place in the processing zone. The inductive furnace provides the necessary heat source to activate and cure the low-temperature resin that has been pre-pregged infused into the inner and outer fabric layers 34, 36. The inductive furnace heats the resin, converting the inner and outer fabric layers 34, 36 to a solid phenolic cover 32. The heating zone and exposure time required to cure the resin are parameters that determine the dimensions of the heating zone. The heating source (i.e., the inductive furnace) is exposed to the entire circumference of the blade assembly as it passes through the heat zone. The induction furnace is then removed from the work zone.

Inspection of the Cover 32 and Application of the Cyclo-Alephatic Resin Skin

At this point the blade 10 is inspected. The inspection examines the surface characteristic of the cover 32. Any surface defects detected are mechanically corrected (e.g., via grinding, milling, or sanding, etc.).

A final step is the application of the finishing resin which serves as the skin of the blade assembly. This is accomplished by placing a resin application enclosure in the work zone. The finishing resin is applied using conventional spraying methodology.

It should be appreciated that the present invention provides numerous advantages over conventional wind turbine blades. For example, the complete fabrication and assembly of the blade 10 at the wind turbine construction site eliminates numerous costly and time consuming non-standard logistical and transportation tasks that are associated with the shipment of a large (e.g., 55 meters long) blade that is fabricated and assembled at a plant that is remotely located from the wind turbine construction site. The components of the blade 10 are transported to the field using standard transportation facilities such as flatbed or container trailers, which dramatically simplifies the logistics of transporting one or multiple sets of turbine blades 10 to the wind turbine construction site. Also, it is believed that the weight of the blade 10 may be reduced compared to the weight of the conventionally constructed wind turbine blades, thereby requiring less wind force to rotate the blade 10. Lighter weight per swept-area of the blades 10 reduces tower reinforcement requirements, reduces the wear on hub bearings, and reduces vibrations and resultant wear on the turbine generating mechanisms. In addition, the cost savings associated with the fabrication of the blade 10 in the field reduces the total fabrication cost. It is also anticipated that the blade 10 should a have service life that extends longer than comparable blades.

It should be noted that the present invention can have numerous modifications and variations. For instance, the foam sections F1-F6 may be made of resin based composites, molded plastic, or any structural suitable light weight core material. Likewise the spar sections S1-S6 may be made of carbon material, composites, or any suitable structural material. Also, alternative structures and mechanisms may be used for the tape layup process. An alternate structure may support the tape reel 40 in a non-moving orientation so that the blade 10 may rotate (rather then the reel 40 itself) to facilitate the layup of the tape thereon. Furthermore, trolleys or other suitable conveying equipment may be utilized in place of conveyors. Although the aforesaid description specifies dimensions for the size and spacing of particular elements of the blade 10, dimensions for the size and spacing of such elements may vary in accordance the size and shape of the blade 10 or other embodiments of the present invention.

It will be understood that the embodiment described herein is merely exemplary and that a person skilled in the art may make many variations and modifications without departing from the spirit and scope of the invention. For instance, all such variations and modifications are intended to be included within the scope of the invention.

What is claimed is:

1. A wind turbine blade, comprising: a core having a plurality of sections; a spar having a plurality of sections, said spar centrally positioned in said core; and a cover formed around the core.

2. A method for fabricating a wind turbine blade, comprising the steps of: assembling a plurality of spar sections to form a spar; positioning a plurality of core sections on said spar; and forming a cover over said core sections.
